(19) United States
(12) Patent Application Publication
(10) Pub. No.: US 2024/0174387 A1
(43) Pub. Date: May 30, 2024

(54) CHARGING PLATFORM AND UNMANNED AERIAL VEHICLE

(71) Applicant: AUTEL ROBOTICS CO., LTD., Nanshan Dist., Shenzhen (CN)

(72) Inventor: Wei QIN, Shenzhen (CN)

(21) Appl. No.: 18/431,357

(22) Filed: Feb. 2, 2024

Related U.S. Application Data
(63) Continuation of application No. PCT/CN2022/110086, filed on Aug. 3, 2022.

(30) Foreign Application Priority Data
Aug. 3, 2021 (CN) 202110888111.0

(51) Int. Cl. B64U 50/37; B60L 53/53

(52) U.S. Cl. CPC B64U 50/37; B60L 53/53

(57) ABSTRACT

The embodiments of the present disclosure relate to a charging platform and an unmanned aerial vehicle. The charging platform includes a charging interface, a control unit, a charging switch, and a charging power supply. A power receiving interface and a battery pack are disposed in the unmanned aerial vehicle. A first end of the power receiving interface is connected to an output end of the battery pack. A second end of the power receiving interface is connected to a charging end of the battery pack. The charging switch is connected in series between the charging power supply and a second end of the charging interface. A power supply end of the control unit is connected to a first end of the charging interface. A first end of the control unit is connected to a control end of the charging switch.

### CROSS-REFERENCE TO RELATED APPLICATIONS

The present application is a continuation of International Application No. PCT/CN2022/110086, filed 3 Aug. 2022, which claims priority to and the benefit of Chinese Patent Application No. 2021108881110, filed Aug. 3, 2021, the entireties of which are hereby incorporated herein by reference.

### TECHNICAL FIELD

The embodiments of the present disclosure relate to the field of charging technologies for unmanned aerial vehicles, and particularly relates to a charging platform and an unmanned aerial vehicle.

### BACKGROUND

With the continuous development of an unmanned aerial vehicle technology, an unmanned aerial vehicle is used more and more widely, for example, is used in military actions, geological survey, logistics transportation, agricultural applications, movie and television photography, fire fighting and disaster relief, rescue inspection, and many other fields. For some specific scenarios, for example, power inspection and forest fire protection applications, the unmanned aerial vehicle usually needs to perform autonomous charging and autonomous cruising.

Currently, a conventional autonomous cruising unmanned aerial vehicle is usually charged in a manner of manually replacing a battery. When the unmanned aerial vehicle is in low battery during a flight, the unmanned aerial vehicle needs to be controlled to return or land, and then the battery of the unmanned aerial vehicle is replaced. As a result, the unmanned aerial vehicle cannot autonomously fly for a long time. In addition, in this manner, the battery needs to be manually disassembled, so that labor costs are high, and intelligence is lower.

### SUMMARY

The embodiments of the present disclosure provide a charging platform and an unmanned aerial vehicle. Autonomous charging can be performed, and the unmanned aerial vehicle can be charging without replacing a battery, so that labor costs are low, and intelligence is high.

According to a first aspect, an embodiment of the present disclosure provides a charging platform, including a charging interface, a control unit, a charging switch, and a charging power supply.

The charging platform is configured to charge an unmanned aerial vehicle. A power receiving interface and a battery pack are disposed in the unmanned aerial vehicle. A first end of the power receiving interface is connected to an output end of the battery pack. A second end of the power receiving interface is connected to a charging end of the battery pack.

A first end of the charging interface is configured to connect the first end of the power receiving interface. A second end of the charging interface is configured to connect the second end of the power receiving interface. The charging switch is connected in series between the charging power supply and the second end of the charging interface. A power supply end of the control unit is connected to the first end of the charging interface. A first end of the control unit is connected to a control end of the charging switch.

When the charging interface is connected to the power receiving interface, the battery pack is configured to power the control unit, such that the control unit outputs a first control signal to the charging switch, to connect a charging loop formed by the charging power supply, the charging switch, the second end of the charging interface, the second end of the power receiving interface, and the battery pack, to enable the charging power supply to charge the battery pack.

According to a second aspect, an embodiment of the present disclosure further provides an unmanned aerial vehicle, including a power receiving interface and a battery pack.

A first end of the power receiving interface is connected to a second output end of the battery pack. A second end of the power receiving interface is connected to a charging end of the battery pack.

The first end of the power receiving interface is further configured to connect a first end of a charging interface of a charging platform. The second end of the power receiving interface is configured to connect a second end of the charging interface. The charging platform is configured to charge the unmanned aerial vehicle. The charging platform further includes a control unit and a charging power supply. The first end of the charging interface is further connected to a power supply end of the control unit. The second end of the charging interface is further connected to the charging power supply.

When the power receiving interface is connected to the charging interface, the battery pack is configured to power the control unit, such that the control unit controls the charging power supply to charge the battery pack.

### BRIEF DESCRIPTION OF THE DRAWINGS

One or more embodiments are described with examples with reference to figures in corresponding accompanying drawings. These exemplary descriptions do not constitute a limitation on the embodiments. Elements/modules and steps with a same reference numeral in the accompanying drawings represent similar elements/modules and steps. Unless otherwise specified, the figures in the accompanying drawings do not constitute a proportion limitation.

FIG. 1 is a schematic block diagram of a structure of a charging system according to an embodiment of the present disclosure,

FIG. 2 is a schematic block diagram of a structure of another charging system according to an embodiment of the present disclosure,

FIG. 3 is a schematic block diagram of a structure of a yet another charging system according to an embodiment of the present disclosure, and

FIG. 4 is a schematic diagram of a working process of a charging system according to an embodiment of the present disclosure.

### DETAILED DESCRIPTION

The present disclosure is described in detail below with reference to specific embodiments. The following embodiments help a person skilled in the art further understand the present disclosure, but are not intended to limit the present disclosure in any form. It should be noted that a person of ordinary skill in the art may make several variants and improvements without departing from the concept of the present disclosure and the variants and improvements shall fall within the protection scope of the present disclosure.

For ease of understanding this application, this application is described in more detail below with reference to the accompanying drawings and specific embodiments. Unless otherwise defined, all technical and scientific terms used in this specification have same meanings as those usually understood by a person skilled in the art of this application. The terms used in the specification of this application are merely for the purpose of describing specific embodiments, and are not intended to limit this application. A term “and/or” used in this specification includes any or all combinations of one or more related listed items.

It should be noted that features in the embodiments of the present disclosure may be combined with one another without conflicts, and all combinations fall within the protection scope of this application. In addition, although function module division is performed in a schematic diagram of an apparatus, module division different from that in the apparatus may be performed in some cases. Moreover, words “first”, “second”, and the like used in this specification do not limit data and an execution order, but are merely for distinguishing between same or similar items whose functions and effects are substantially the same.

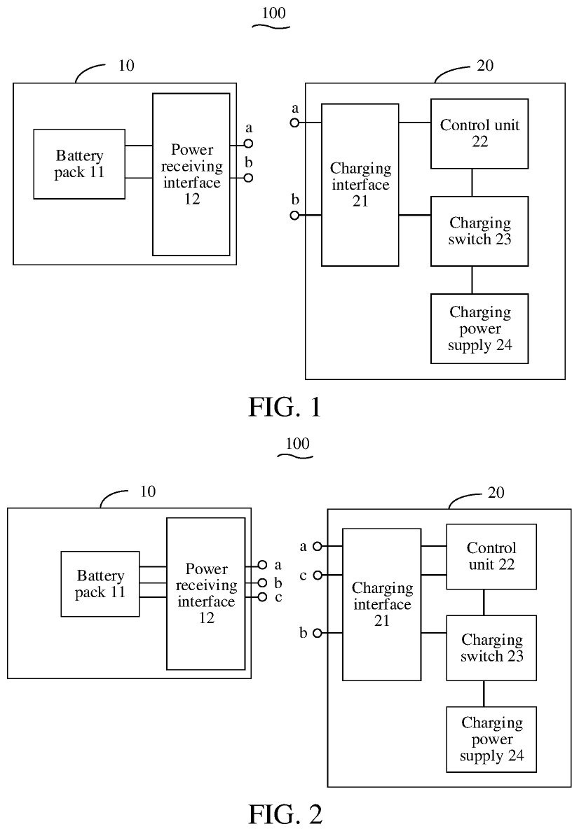

An embodiment of the present disclosure provides a charging system. Referring to FIG. 1, the charging system 100 includes an unmanned aerial vehicle 10 and a charging platform 20. A battery pack 11 and a power receiving interface 12 are disposed in the unmanned aerial vehicle. An output end of the battery pack 11 is connected to a first end a of the power receiving interface 12. A charging end of the battery pack 11 is connected to a second end b of the power receiving interface 12. The charging platform 20 includes a charging interface 21, a control unit 22, a charging switch 23, and a charging power supply 24. A first end a of the charging interface 21 is connected to a power supply end of the control unit 22. The charging switch 23 is connected in series between the charging power supply 24 and a second end b of the charging interface 21. A first end of the control unit 22 is connected to a control end of the charging switch 23.

The first end a of the charging interface 21 is configured to connect the first end a of the power receiving interface 12. The second end b of the charging interface 21 is configured to connect the second end b of the power receiving interface 12. In this way, when the unmanned aerial vehicle 10 is connected to the charging platform 20, that is, when the power receiving interface 12 is connected to the charging interface 21, the battery pack 11 powers the control unit 22, such that the control unit 22 outputs a first control signal to the charging switch 23, to connect a charging loop formed by the charging power supply 24, the charging switch 23, the second end b of the charging interface 21, the second end b of the power receiving interface 12, and the battery pack 11, to enable the charging power supply 24 to charge the battery pack 11.

In this charging system 100, when the unmanned aerial vehicle 10 is connected to the charging platform 20, that is, when the power receiving interface 12 is connected to the charging interface 21, the first end a of the power receiving interface 12 is connected to the first end a of the charging interface 21, the first end a of the power receiving interface 12 is connected to the second end b of the charging interface 21, the battery pack 11 releases electric energy through an output end, and the electric energy flows to the power supply end of the control unit 22 through the power receiving interface 12. Then, after powered, the control unit 22 outputs the first control signal to the charging switch 23 to turn on the charging switch 23, to connect the charging loop from the charging power supply 24 to the battery pack 11, such that the battery pack 11 enters a charging state. Specifically, the power receiving interface 12 and the charging interface 21 may be metal contacts, structural metal components, or any other structure that may be configured to transmit the electric energy in the prior art. No limitations are made herein.

It can be seen that when the unmanned aerial vehicle is in low battery, the unmanned aerial vehicle may land in a specific charging region and look for the charging platform 20 provided in this embodiment of the present disclosure for charging. In this charging manner, a battery of the unmanned aerial vehicle does not need to be manually replaced, so that labor costs are reduced. In addition, in the charging system 100, the control unit 22 of the charging platform 20 is powered by the battery pack 11 of the unmanned aerial vehicle rather than the charging power supply 24 of the charging platform 20. Awakening the charging platform 20 in this power supply manner to work not only may implement in-position detection between the unmanned aerial vehicle 10 and the charging platform 20, but also may reduce wasting of idle time of the charging platform 20 and enable the unmanned aerial vehicle to be autonomously charged when landing on the charging platform 20, so that intelligence of the charging system 100 is improved.

In some other embodiments, the charging platform may include no charging switch. In this case, the first end of the charging interface is connected to the power supply end of the control unit, the second end of the charging interface is connected to a first end of the charging power supply, and the first end of the control unit is directly connected to the charging power supply. After the control unit is powered, an output of the charging power supply may be directly controlled, to control a charging status of the battery pack.

For ease of data exchange between the unmanned aerial vehicle and the charging platform, in some embodiments, referring to FIG. 2, a third end c of the charging interface 21 is connected to a communication end of the control unit 22. The third end c of the charging interface 21 is configured to connect a third end c of the power receiving interface 12. The third end c of the power receiving interface 12 is connected to a communication end of the battery pack 11. In this way, when the power receiving interface 12 is connected to the charging interface 21, the third end c of the power receiving interface 12 is connected to the third end c of the charging interface 21, so that the unmanned aerial vehicle 10 performs communication connection to the charging platform 20 through a communication port, to implement data communication. In the present disclosure, the battery pack 11 is a battery pack capable to perform data communication, and may be in communication connection to the control unit 22. In some embodiments, the battery pack 11 has a communication port, and may be in wired connection to the third end c of the power receiving interface 12. In some other embodiments, the battery pack 11 has a wireless communication module, for example, a Bluetooth module, a cellular module, or a local area network module, and can directly perform wireless communication connection to the control unit 22. During actual application, a communication connection manner between the control unit 22 and the battery pack 11 is not limited to this embodiment as long as data communication can be performed.

In some embodiments, in the charging system, when the power receiving interface 12 is connected to the charging interface 21, that is, after the unmanned aerial vehicle 10 establishes a communication connection to the charging platform 20, the battery pack 11 is further configured to send charging parameter information of the battery pack 11 to the control unit 22, and the control unit 22 is further configured to receive the charging parameter information of the battery pack 11. Specifically, when the unmanned aerial vehicle 10 is connected to the charging platform 20, after the control unit 22 is powered, the control unit 22 communicates with the battery pack 11 through the communication end, and obtains a voltage, a charging status, a battery level, and battery model information of a battery in the battery pack 11. Therefore, the control unit 22 may determine, in a subsequent charging process according to the battery parameter information, a voltage and a current to be output by the charging power supply to the battery of the unmanned aerial vehicle, to ensure safety of the battery pack 11 and prolong service life of the battery pack 11.

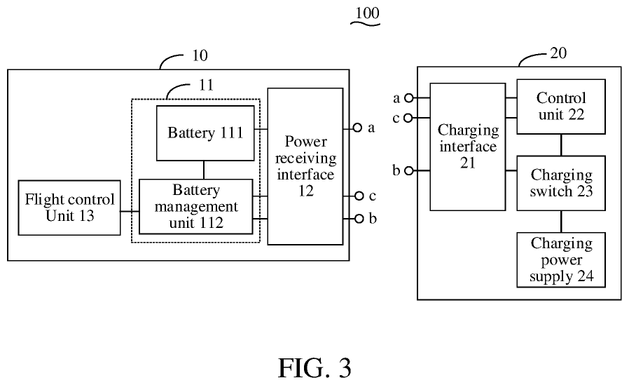

In some embodiments, referring to FIG. 3, the battery pack 11 includes a battery 111 and a battery management unit 112. A first end of the battery 111 is connected to a first end of the battery management unit 112. A power supply end of the battery management unit 112 is connected to a flight control unit 13. The first end a of the power receiving interface 12 is connected to a second end of the battery 111. The second end b of the power receiving interface 12 is connected to a charging end of the battery management unit 112. The third end c of the power receiving interface 12 is connected to a communication end of the battery management unit 112.

The battery management unit 112 is configured to control a charging/discharging status of the battery 111. In the charging system 100, when the power receiving interface 12 of the unmanned aerial vehicle 10 is connected to the charging interface 21 of the charging platform 20, the battery 111 releases electric energy to the power supply end of the control unit 22 through the second end. The control unit 22 is powered, and outputs the first control signal to the charging switch 23 to turn on the charging switch 23, to connect the charging loop formed by the charging power supply 24, the charging switch 23, the second end b of the charging interface 21, the second end b of the power receiving interface 12, the battery management unit 112, and the battery 111, such that the battery 111 enters the charging state. In addition, the control unit 22 communicates and performs data exchange with the battery management unit 112 in a charging process. In the charging system 100, the charging loop of the battery 111 passes through the battery management unit 112, so that the battery management unit 112 may be configured to perform charging protection in the charging process, to ensure reliability and safety of the charging system 100.

In some embodiments, the battery management unit consists of a microprocessor and a switch circuit. For a specific circuit structure of the battery management unit, reference may be made to a circuit structure in the prior art, and no limitations are made herein. The microprocessor and the control unit each may be an STM8, STM16, or STM32 microcontroller processor or any other appropriate microcontroller processor or single-chip microcomputer that may be configured to receive, process, and output data. No limitations are made herein.

Generally, the battery pack is mounted to a body of the unmanned aerial vehicle, and is usually in a state of powering the flight control unit with a high power supply current. If the battery pack is charged in this case, the battery is easily damaged. To avoid such damage, in some embodiments, when the power receiving interface is connected to the charging interface, the control unit is further configured to send a power-off instruction to the battery management unit before outputting the first control signal. After receiving the power-off instruction of the control unit, the battery management unit controls the battery to stop powering the flight control unit. It should be noted that referring to FIG. 3, when the power receiving interface 12 is connected to the charging interface 21, the second end of the battery 111 is directly connected to the power supply end of the control unit 22, and the power supply loop does not pass through the battery management unit 112. Therefore, the battery management unit 112 may not affect power supply of the control unit 22 by the battery 111 when executing the power-off instruction, and the charging system is still in a normal charging working state.

In some embodiments, the battery management unit is further configured to detect, when the battery is charged, whether the battery is in a normal charging state, and is configured to give an alarm when the battery is in an abnormal charging state. Specifically, the battery pack further includes a charging current detection unit and a temperature detection unit. The charging current detection unit is connected in series to the charging loop. The battery management unit is respectively connected to the charging current detection unit and the temperature detection unit. The temperature detection unit is configured to detect a temperature of the battery and send the temperature of the battery to the battery management unit. In the charging system, when the battery is charged, the battery management unit may detect, through the temperature detection unit, whether the temperature of the battery is normal, detect, through the charging current detection unit, whether a charging current is normal, and when the temperature of the battery is not within a preset temperature range and/or the charging current exceeds a preset current value, give an alarm, to prevent the battery from an overtemperature or overcurrent charging. It may be understood that the battery management unit may further be configured to detect whether a charging voltage of the battery pack is abnormal and whether there is a short-circuit during charging, or monitor another safety alarm triggering event, and if there is an abnormality, give an alarm.

Specifically, in some embodiments, the charging system further includes an alarm apparatus connected to a charging management unit, for example, a display screen, at least one light-emitting diode (LED), a buzzer, a microphone, a vibrator, or any other appropriate alarm apparatus. When detecting that the battery pack is in an abnormal charging state, the battery management unit controls the alarm apparatus to work. For a specific process in which the battery management unit controls the alarm apparatus, reference may be made to the prior art, and no limitations are made herein.

In some embodiments, the battery management unit is further configured to send alarm information to the control unit when an alarm event occurs. The control unit is further configured to output, after receiving the alarm information, a second control signal to the charging switch, to disconnect the charging loop. In this way, the charging loop is disconnected, and the control unit controls the charging power supply to stop charging the battery pack, to ensure system safety.

To improve system reliability, in some embodiments, the battery management unit is further configured to send charging completion information to the control unit when charging of the battery is completed. The control unit is further configured to receive the charging completion information, and output, according to the charging completion information, the second control signal to the charging switch, to disconnect the charging loop to control the charging power supply to stop charging the battery pack. In this way, after charging of the battery is completed, the battery management unit sends the charging completion information to the control unit, and the control unit outputs the second control signal to the charging switch, to disconnect the charging loop. Specifically, the charging switch may be a relay, a metal-oxide semiconductor (MOS) transistor, an insulated gate bipolar transistor (IGBT), or any other appropriate switch circuit. No limitations are made herein.

To further improve system intelligence, in some embodiments, after performing the step of disconnecting the charging loop according to the charging completion information, the control unit further sends a power-on instruction to the battery management unit. The battery management unit is configured to power the flight control unit again after receiving the power-on instruction, such that the unmanned aerial vehicle enters a normal working state. Therefore, system intelligence is improved.

The following describes, in detail with reference to the charging system shown in FIG. 3, a specific working process of the charging system provided in this embodiment of the present disclosure.

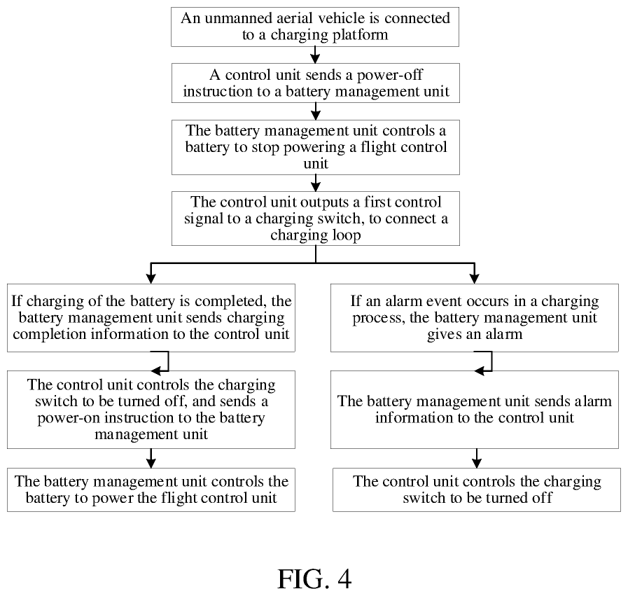

Referring to FIG. 3 and FIG. 4, after the power receiving interface 12 of the unmanned aerial vehicle 10 is connected to the charging interface 21 of the charging platform, the control unit 22 is powered. The control unit 22 first sends a power-off instruction to the battery management unit 112 through the communication end. The battery management unit 112 stops power supply of the flight control unit 13 by the battery 111 according to the power-off instruction. Then, the control unit 22 outputs a first control signal to the charging switch 23 to turn on the charging switch 23, to connect the charging loop formed by the charging power supply 24, the charging switch 23, the second end of the charging interface 21, the second end of the power receiving interface 12, the battery management unit 112, and the battery 111, such that the battery 111 enters a charging state. Next, in a charging process of the battery 111, the battery management unit 112 monitors the charging process of the battery 111, and if a safety alarm event occurs, gives an alarm to indicate manual intervention, or sends alarm information to the control unit 22, such that the control unit 22 turns off the charging switch 23 according to the alarm information, to disconnect the charging loop to protect the battery 111. After charging of the battery 111 is completed, the battery management unit 112 sends charging completion information to the control unit 22. The control unit 22 turns off the charging switch according to the charging completion information, and sends a power-on instruction to the battery management unit 112. The battery management unit 112 powers the flight control unit 13 again according to the power-on instruction, such that the unmanned aerial vehicle 10 enters a normal working state. It can be seen from the above that in the charging system, the battery of the unmanned aerial vehicle does not need to be manually replaced, and the unmanned aerial vehicle is autonomously charged, so that intelligence is high.

In some embodiments, a third end of the charging interface is connected to a communication end of the control unit. The third end of the charging interface is configured to connect a third end of the power receiving interface. The third end of the power receiving interface is connected to a communication end of the battery pack.

In some embodiments, the control unit is further configured to receive charging parameter information of the battery pack when the power receiving interface is connected to the charging interface.

In some embodiments, a flight control unit configured to drive the unmanned aerial vehicle to run is disposed in the unmanned aerial vehicle. The battery pack includes a battery and a battery management unit.

A first end of the battery is connected to a first end of the battery management unit. A power supply end of the battery management unit is connected to the flight control unit. The first end of the power receiving interface is connected to a second end of the battery. The second end of the power receiving interface is connected to a charging end of the battery management unit. The third end of the power receiving interface is configured to connect a communication end of the battery management unit.

When the power receiving interface is connected to the charging interface, the control unit is further configured to send a power-off instruction to the battery management unit before outputting the first control signal. The power-off instruction is used to instruct the battery to stop powering the flight control unit.

In some embodiments, the control unit is further configured to receive alarm information of the battery management unit, and output a second control signal to the charging switch according to the alarm information, to disconnect the charging loop.

In some embodiments, the control unit is further configured to receive charging completion information sent by the battery management unit, and output the second control signal to the charging switch according to the charging completion information, to disconnect the charging loop.

In some embodiments, the control unit is further configured to send a power-on instruction to the battery management unit after receiving the charging completion information and disconnecting the charging loop. The power-on instruction is used to instruct the unmanned aerial vehicle to normally run.

The present disclosure provides a charging platform and an unmanned aerial vehicle. The charging platform includes a charging interface, a control unit, a charging switch, and a charging power supply. A power receiving interface and a battery pack are disposed in the unmanned aerial vehicle. A first end of the power receiving interface is connected to an output end of the battery pack. A second end of the power receiving interface is connected to a charging end of the battery pack. The charging switch is connected in series between the charging power supply and a second end of the charging interface. A power supply end of the control unit is connected to a first end of the charging interface. A first end of the control unit is connected to a control end of the charging switch. When the power receiving interface is connected to the charging interface, the battery pack powers the control unit, and the control unit outputs a first control signal to the charging switch, to connect a charging loop to enable the charging power supply to charge the battery pack. According to such a charging system, a battery does not need to be manually disassembled, and autonomous charging can be performed, so that labor costs are low, and intelligence is high.

In some embodiments, a third end of the power receiving interface is connected to a communication end of the battery pack. The third end of the power receiving interface is further configured to connect a third end of the charging interface. The third end of the charging interface is connected to a communication end of the control unit.

In some embodiments, the battery pack is further configured to send charging parameter information of the battery pack to the control unit when the power receiving interface is connected to the charging interface.

In some embodiments, a flight control unit configured to drive the unmanned aerial vehicle to run is disposed in the unmanned aerial vehicle. The battery pack includes a battery and a battery management unit.

A first end of the battery is connected to a first end of the battery management unit. A power supply end of the battery management unit is connected to the flight control unit. The first end of the power receiving interface is connected to a second end of the battery. The second end of the power receiving interface is connected to a charging end of the battery management unit. The third end of the power receiving interface is connected to a communication end of the battery management unit.

In some embodiments, the battery management unit is further configured to receive a power-off instruction of the control unit, control, according to the power-off instruction, the battery to stop powering the flight control unit, receive a power-on instruction of the control unit, and control, according to the power-on instruction, the battery to power the flight control unit.

In some embodiments, the battery management unit is further configured to send alarm information to the control unit in a case of an alarm. The alarm information is used to instruct the control unit to control the charging power supply to stop charging the battery pack.

In some embodiments, the battery management unit is further configured to send charging completion information to the control unit when charging of the battery pack is completed. The charging completion information is used to instruct the control unit to control the charging power supply to stop charging the battery pack.

Compared with the prior art, the present disclosure has the following beneficial effects. Different from a case in the prior art, the present disclosure provides the charging platform and the unmanned aerial vehicle. The charging platform includes the charging interface, the control unit, the charging switch, and the charging power supply. The power receiving interface and the battery pack are disposed in the unmanned aerial vehicle. The first end of the power receiving interface is connected to the output end of the battery pack. The second end of the power receiving interface is connected to the charging end of the battery pack. The charging switch is connected in series between the charging power supply and the second end of the charging interface. The power supply end of the control unit is connected to the first end of the charging interface. The first end of the control unit is connected to the control end of the charging switch. When the power receiving interface is connected to the charging interface, the battery pack powers the control unit, and the control unit outputs the first control signal to the charging switch, to connect the charging loop to enable the charging power supply to charge the battery pack. According to such a charging system, the battery does not need to be manually disassembled, and autonomous charging can be performed, so that labor costs are low, and intelligence is high.

It should be noted that the described apparatus embodiment is merely illustrative. The units described as separate parts may or may not be physically separated. Parts shown as units may or may not be physical modules, and may be located at one location, or may be distributed on a plurality of network units. Some or all of the modules may be selected according to actual needs to achieve the objectives of the solutions of the embodiments.

Finally, it should be noted that the foregoing embodiments are merely used for describing the technical solutions of the present disclosure, but are not intended to limit the present disclosure. Under the ideas of the present disclosure, the technical features in the foregoing embodiments or different embodiments may also be combined, the steps may be performed in any order, and many other changes of different aspects of the present disclosure also exists as described above, and these changes are not provided in detail for simplicity. Although the present disclosure is described in detail with reference to the foregoing embodiments, it should be understood by a person skilled in the art that modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of the present disclosure.

What is claimed is:

1. A charging platform, comprising a charging interface, a control unit, a charging switch, and a charging power supply, wherein
the charging platform is configured to charge an unmanned aerial vehicle, a power receiving interface and a battery pack are disposed in the unmanned aerial vehicle, a first end of the power receiving interface is connected to an output end of the battery pack, and a second end of the power receiving interface is connected to a charging end of the battery pack;
a first end of the charging interface is configured to connect the first end of the power receiving interface, a second end of the charging interface is configured to connect the second end of the power receiving interface, the charging switch is connected in series between the charging power supply and the second end of the charging interface, a power supply end of the control unit is connected to the first end of the charging interface, and a first end of the control unit is connected to a control end of the charging switch; and
when the charging interface is connected to the power receiving interface, the battery pack is configured to power the control unit, such that the control unit outputs a first control signal to the charging switch, to connect a charging loop formed by the charging power supply, the charging switch, the second end of the charging interface, the second end of the power receiving interface, and the battery pack, to enable the charging power supply to charge the battery pack.

2. The charging platform according to claim 1, wherein a third end of the charging interface is connected to a communication end of the control unit, the third end of the charging interface is configured to connect a third end of the power receiving interface, and the third end of the power receiving interface is connected to a communication end of the battery pack.

3. The charging platform according to claim 2, wherein the control unit is further configured to receive charging parameter information of the battery pack when the power receiving interface is connected to the charging interface.

4. The charging platform according to claim 2, wherein a flight control unit configured to drive the unmanned aerial vehicle to run is disposed in the unmanned aerial vehicle, and the battery pack comprises a battery and a battery management unit;
a first end of the battery is connected to a first end of the battery management unit, a power supply end of the battery management unit is connected to the flight control unit, the first end of the power receiving interface is connected to a second end of the battery, the second end of the power receiving interface is connected to a charging end of the battery management unit, and the third end of the power receiving interface is configured to connect a communication end of the battery management unit; and
when the power receiving interface is connected to the charging interface, the control unit is further configured to send a power-off instruction to the battery management unit before outputting the first control signal, wherein the power-off instruction is used to instruct the battery to stop powering the flight control unit.

5. The charging platform according to claim 4, wherein the control unit is further configured to receive alarm information of the battery management unit, and output a second control signal to the charging switch according to the alarm information, to disconnect the charging loop.

6. The charging platform according to claim 5, wherein the control unit is further configured to receive charging completion information sent by the battery management unit, and output the second control signal to the charging switch according to the charging completion information, to disconnect the charging loop.

7. The charging platform according to claim 6, wherein the control unit is further configured to send a power-on instruction to the battery management unit after receiving the charging completion information and disconnecting the charging loop, wherein the power-on instruction is used to instruct the unmanned aerial vehicle to normally run.

8. An unmanned aerial vehicle, comprising a power receiving interface and a battery pack, wherein
a first end of the power receiving interface is connected to a second output end of the battery pack, and a second end of the power receiving interface is connected to a charging end of the battery pack; the first end of the power receiving interface is further configured to connect a first end of a charging interface of a charging platform, and the second end of the power receiving interface is configured to connect a second end of the charging interface, wherein the charging platform is configured to charge the unmanned aerial vehicle, the charging platform further comprises a control unit and a charging power supply that are connected to each other, the first end of the charging interface is further connected to a power supply end of the control unit, and the second end of the charging interface is further connected to the charging power supply; and
when the power receiving interface is connected to the charging interface, the battery pack is configured to power the control unit, such that the control unit controls the charging power supply to charge the battery pack.

9. The unmanned aerial vehicle according to claim 8, wherein a third end of the power receiving interface is connected to a communication end of the battery pack, the third end of the power receiving interface is further configured to connect a third end of the charging interface, and the third end of the charging interface is connected to a communication end of the control unit.

10. The unmanned aerial vehicle according to claim 9, wherein the battery pack is further configured to send charging parameter information of the battery pack to the control unit when the power receiving interface is connected to the charging interface.

11. The unmanned aerial vehicle according to claim 9, wherein a flight control unit configured to drive the unmanned aerial vehicle to run is disposed in the unmanned aerial vehicle, and the battery pack comprises a battery and a battery management unit; and
a first end of the battery is connected to a first end of the battery management unit, a power supply end of the battery management unit is connected to the flight control unit, the first end of the power receiving interface is connected to a second end of the battery, the second end of the power receiving interface is connected to a charging end of the battery management unit, and the third end of the power receiving interface is connected to a communication end of the battery management unit.

12. The unmanned aerial vehicle according to claim 11, wherein the battery management unit is further configured to receive a power-off instruction of the control unit, control, according to the power-off instruction, the battery to stop powering the flight control unit, receive a power-on instruction of the control unit, and control, according to the power-on instruction, the battery to power the flight control unit.

13. The unmanned aerial vehicle according to claim 12, wherein the battery management unit is further configured to send alarm information to the control unit in a case of an alarm, wherein the alarm information is used to instruct the control unit to control the charging power supply to stop charging the battery pack.

14. The unmanned aerial vehicle according to claim 12, wherein the battery management unit is further configured to send charging completion information to the control unit when charging of the battery pack is completed, wherein the charging completion information is used to instruct the control unit to control the charging power supply to stop charging the battery pack.
